(19) United States
(12) Patent Application Publication
(10) Pub. No.: US 2005/0242753 A1
(43) Pub. Date: Nov. 3, 2005

(54) Automatic and manual wall switch device

(76) Inventors: Randall L. Morrison, Oviedo, FL (US); Kim P. Fallon, Apopka, FL (US)

Correspondence Address: Michael L. Leetzow, Esq.;Michael L. Leetzow, P.A., 5213 SHORELINE CIRCLE, SANFORD, FL, 32771, US

(21) Appl. No.: 11/023,223

(22) Filed: Dec. 27, 2004

Related U.S. Application Data
(63) Continuation-in-part of application No. 29/204,725, filed on May 3, 2004, now Pat. No. D500687.

(51) Int. Cl. B60L 1/00

(52) U.S. Cl. 315/360

(57) ABSTRACT

An electrical wall switch for turning ON and OFF electrical loads has automatic and manual modes. The wall switch has a display for showing time of day and ON and OFF times. The operation of control switches and their relative placement simplifies setting and using the wall switch. The wall switch includes surge suppression for protection.

### FIELD OF THE INVENTION

The invention relates to the area of electrical wall mounted switches for switching on and off electrical loads.

### BACKGROUND OF THE INVENTION

Electric timers and switches are used in households, businesses and institutions to automatically operate electric appliances, lighting and other electrical devices. One type of electrical timer is used as a substitute for a conventional electric wall switch. This type of electric timer replaces a conventional wall switch with a timer that has an ability to automatically operate whatever had been previously operated by the wall switch. Another type of electric timer has the ability to automatically operate an intended light or appliance while providing the function of a conventional wall switch “ON” and “OFF” operation by an integrated manual override switch built into the timer.

However, these devices are not easy to use or user friendly and do not have the look or feel of a conventional wall switch. Thus, what is needed is an electrical wall switch device for automatically turning on and off an electrical load that has the conventional look and feel of a manual wall switch. Such a device should also be a replacement for a standard wall switch without a requirement to frequently replace a battery. Furthermore, prior art electrical timers are not easy to use or user friendly. Thus, what is needed is a programmable timer that is easy to use and user friendly with the look and feel of a conventional wall switch. The programmable timer should fit in a conventional single or multiple gang electrical box for housing conventional manual wall switches and preferably have a rectangular control surface occupying the control area providing a conventional DECORA-type wall plate.

### SUMMARY OF THE INVENTION

In accordance with the present invention, an electrical wall switch device for automatically and manually turning on and off an electrical load has a control surface occupying a compact predefined area that includes a manual load control switch occupying a first portion of the predefined area for receiving manual inputs for turning on and off the electrical load and a time display for displaying time of day, a load on time and a load off time, said time display occupying a second portion of the predefined area, wherein the first portion of the predefined area appears larger than the second portion of the predefined area.

In accordance with the present invention, a simple to program electrical wall switch device for automatically and manually turning on and off an electrical load comprises a time display for displaying time of day, a load turn on time and a load turn off time. The switch further comprises a manual load control switch for receiving manual inputs for turning on and off the electrical load, a display control switch containing three positions, a first of three positions for causing display of the load turn on time on said time display, a second of three positions for causing display of the time of day on said time display, and a third of three positions for causing display of the load turn off time on said time display. The switch further comprises a mode switch comprising at least two positions, a first of the at least two positions enabling turning on and off the electrical load by said manual load control switch, and a second of the at least two positions enabling automatic load control.

In accordance with the present, an electrical wall switch device having a multiplicity of control switches for automatically and manually turning on and off an electrical load. The electrical wall switch device has a control surface occupying a compact predefined area that comprises a manual load control switch of the multiplicity of control switches occupying a first portion of the predefined area for receiving manual inputs for turning on and off the electrical load, and a remainder of the multiplicity control switches comprised within a second portion of the predefined area, wherein the first portion of the predefined area appears larger than the second portion of the predefined area.

### BRIEF DESCRIPTION OF THE DRAWINGS

FIG. 1 shows the appearance of a preferred embodiment of the invention.

FIG. 2 shows the appearance of a compact predefined control area defined by an opening in a switch plate in accordance with the present invention.

FIG. 3, FIG. 4 and FIG. 5 show the top, front and side views of the electrical wall switch in accordance with the present invention.

FIG. 6 shows a flow diagram including manual and automatic load switching in accordance with the operation of the present invention.

FIG. 7 shows a flow diagram including time setting and additional automatic load switching operations in accordance with the operation of the present invention.

FIG. 8 shows a process flow routine of a watch dog timer operating in accordance with the operation of the present invention.

FIG. 9 shows a process flow routine of timer A operating in accordance with the operation of the present invention.

FIG. 10 shows a process flow routine for the processing of a timer A event in accordance with the operation of the present invention.

FIG. 11 shows a process flow routine for retrieving on and off times from nonvolatile flash memory.

FIG. 12 shows a process flow routine for saving on and off times in nonvolatile flash memory.

FIG. 13 shows a block diagram of the electrical wall switch operating in accordance with the present invention.

### DETAILED DESCRIPTION OF THE INVENTION

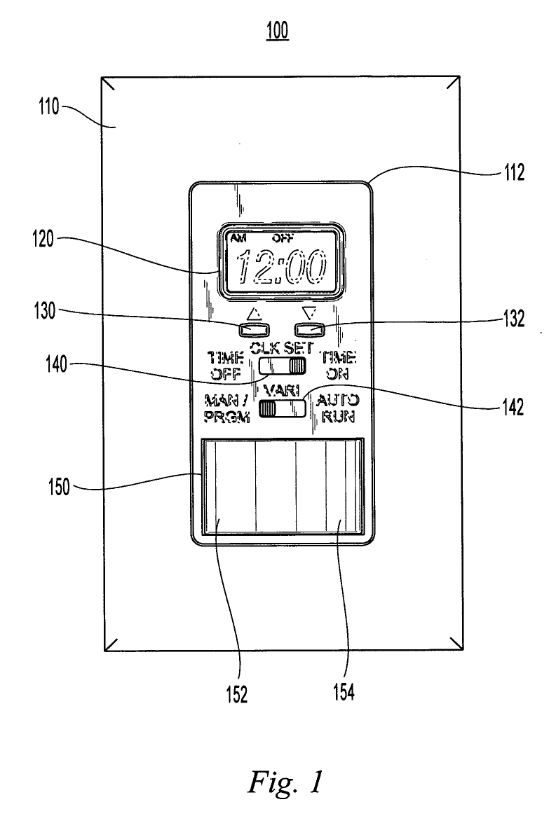

FIG. 1 shows the appearance of a preferred embodiment of the invention 100. A single gang DECORA style switch plate 110 has an opening 112 defining a compact predefined area for a control surface. The predefined area measures substantially one and one half inches by two and six tenths inches. The control surface of the electrical wall switch of the present invention occupies the predefined opening 112 and has a LCD display 120, which may include a backlight for viewing in the dark, an increment switch 130 for incrementing time settings and a decrement switch 132 for decrementing time settings. Further included is a three positing side switch 140 which functions as a display control for controlling setting of a load turn on time, time of day or a load turn off time dependent upon the position of the three position switch. Further included is a mode switch 142 for setting the operation mode of the wall switch. The operating modes include manual operation or automatic operation based on time of day. During manual operation the electrical load is controlled by the large manual load control switch 150. Preferably the manual load control switch is a latching rocker-type switch such that when a manual input is received at location 152 the switch rocks to the left and the load is switched OFF while a manual input received at location 154 rocks the switch to the right and the load is switched ON. During automatic operation the load is controlled by the time of day and the load turn on time and the load turn off time. There are two types of automatic modes, the automatic run mode and the variable mode. In the automatic run mode the load is switched on and off when the time of day corresponds to the load turn on and off times respectively. In the variable mode the load is switched on and off by at least partially random intervals, substantially within fifteen minutes of the load turn on and off times.

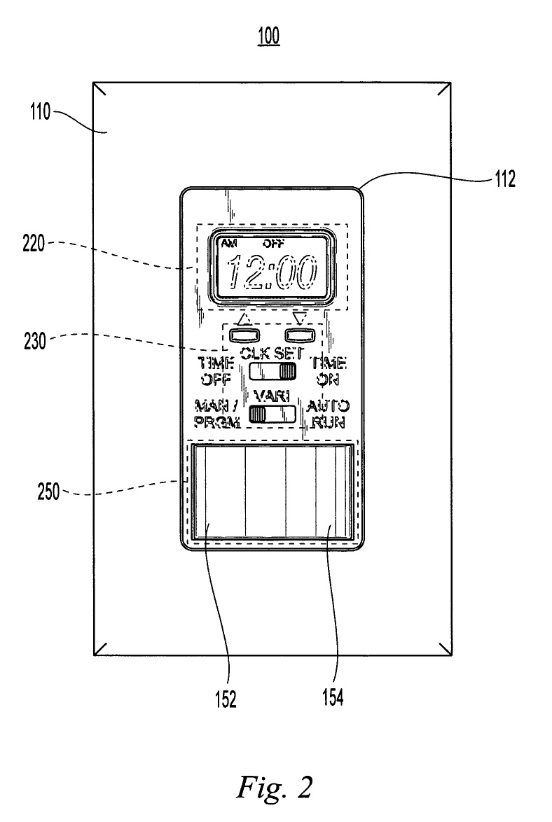

FIG. 2 shows the compact predefined control area defined by opening 112 in switch plate 110 in accordance with the present invention. Opening 112 is substantially comprised of three portions. One portion enclosed in dashed rectangle 220 corresponds to the time display 120. The other two portions have a multiplicity of control switches 130, 132, 140, 142 and 150. The manual load control switch 150 of the multiplicity of control switches is included in the area enclosed by dashed rectangle 250 which defines another portion of predefined control area 112. The remainder of the multiplicity of control switches 130-142 are included in another area defined by dashed rectangle 230 of the predefined control area 112. The relative proportions of the three areas 220, 230, and 250 facilitate the ease of operation of the device and the conventional look and feel of the device. Area 250 appears larger than either area 220 or 230. This appearance tends to produce a perception of a more conventional look and feel.

It should be appreciated that the multiplicity of control switches 130-150 are shown in their preferred embodiment. Other types of switches are anticipated in alternate embodiments. For example, latching rocker-type load switch 150 can alternately be implemented by either a latching toggle-type load switch, a latching snap action-type load switch, a momentary rocker-type load switch, a momentary toggle-type load switch, a momentary snap action-type load switch, a momentary membrane-type load switch, a vertically mounted rocker-type load switch, a horizontally toggle-type load switch, or other type switch providing a similar function.

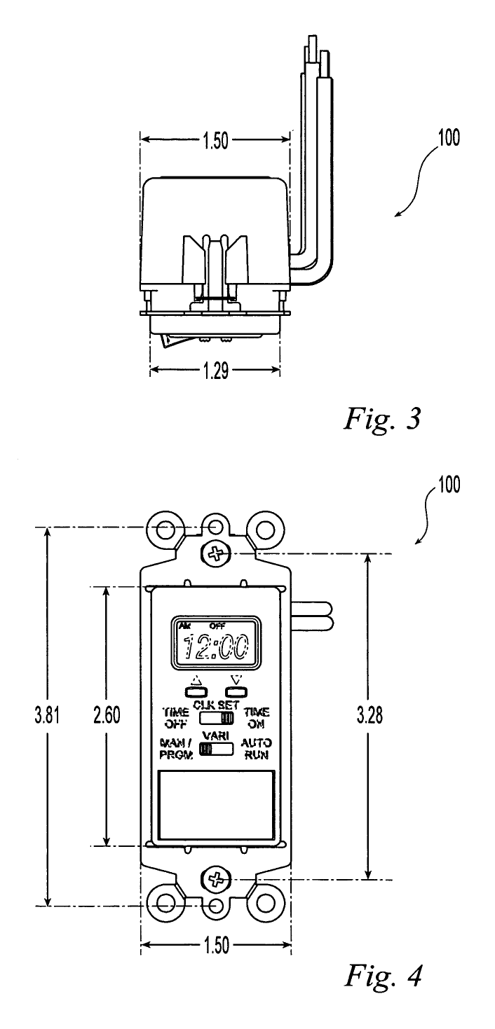

FIG. 3, FIG. 4 and FIG. 5 show the top, front and side views of the electrical wall switch in accordance with the present invention. The dimensions indicate the switch fits within a standard single gang electrical box with a DECORA switch plate. Those familiar with the art will appreciate that the switch will also fit within a standard multiple gang electrical box.

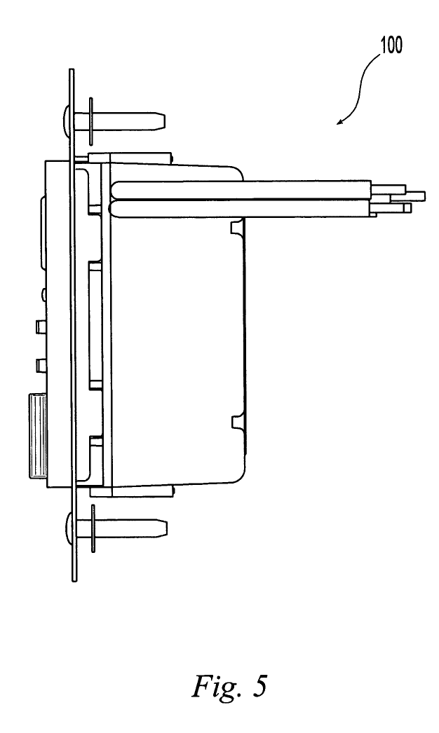

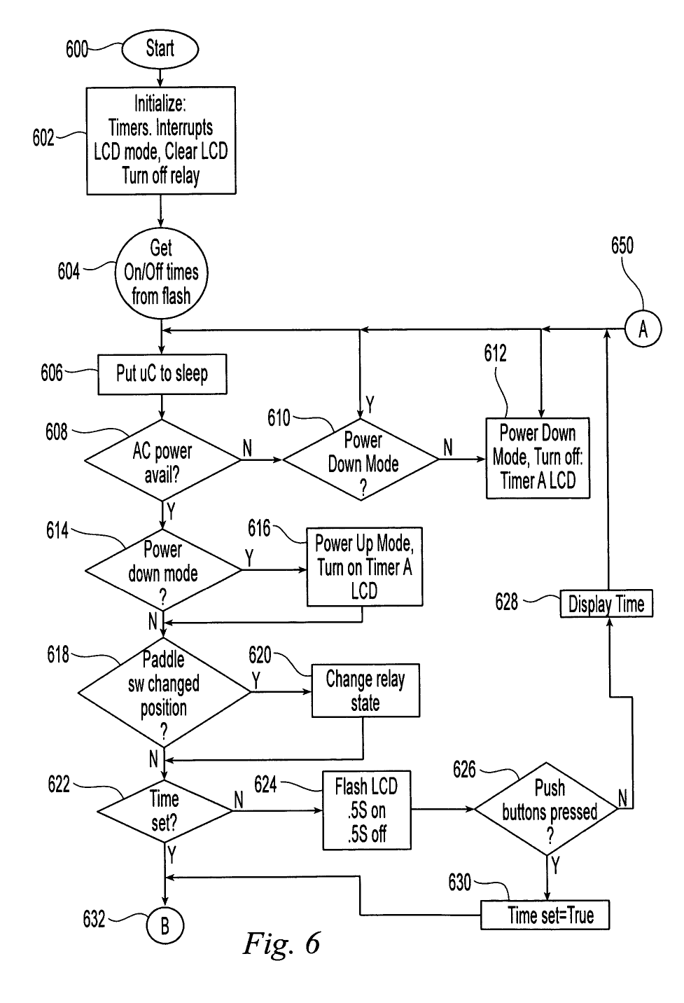

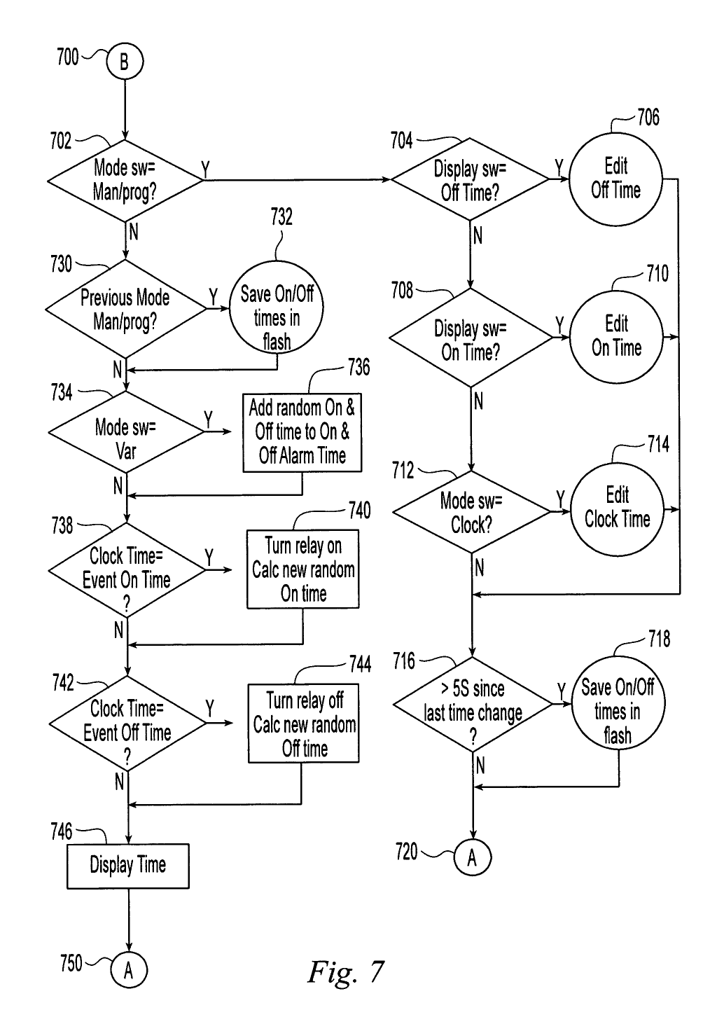

FIG. 6 shows a flow diagram including manual and automatic load switching in accordance with the operation of the present invention. The process begins at step 600. The process begins here for example at an initial power on or after and external reset. Step 602 initializes times, interrupts, the LCD operating mode is cleared and the load switching relay is switched off. Step 604 retrieves load on and off times from non-volatile memory. In step 606 the microprocessor is put to sleep to conserve power consumption. If electrical power for the external source is not available at step 608 and if the microcomputer in the power down mode at step 610, then the microcomputer continues to sleep at step 606. If not in the power down mode, then timer A and the LCD are turned off at step 612 prior to returning to microcomputer sleep step 606. If AC power is available and the power down mode is determined at step 614, then timer A and the LCD are turned on at step 616. Then step 618 determines if the paddle switch, or the manual load control switch, has changed position. If true, the status of the power switching relay is changed at step 620. If step 622 determines that the time set mode is not set then the LCD is caused to flash on and off at 0.5 second intervals at step 624. Then, if no push buttons are pressed at step 626 the time is displayed at step 628 and the process returns to microprocessor sleep step 606. If however pushbuttons are pressed at step 626 then the time set mode is true and step 632, connector A to FIG. 7 is entered from steps 622 or 630.

FIG. 7 shows a flow diagram including time setting and additional automatic load switching operations in accordance with the operation of the present invention. The process flow enters at step 700, connector A. If the manual/program mode by the mode switch is selected at step 702, then step 704 determines if the display control switch has selected the load turn off time setting. If so, step 706 increments or decrements the load turn off time in response to manual activation of increment and decrement switches. If however, the display control switch has selected the load turn on time setting at step 708, step 710 increments or decrements the load turn on time in response to manual activation of increment and decrement switches. If however, the display control switch has selected clock time setting at step 712, step 714 increments or decrements the clock time of day in response to manual activation of increment and decrement switches. If at step 716 more than half a second has elapsed from the last time change then the edited time from either steps 706, 710 or 714 is saved in nonvolatile memory at step 718 and the process returns to FIG. 6 through connector A at step 720. If the manual/program mode by the mode switch position is not selected at step 702 and if previous mode switch position was determined to be manual/program at step 730, then the edited time from either steps 706, 710 or 714 is saved in nonvolatile memory at step 732. If the mode switch position corresponds to the variable mode at step 734, then random on and off times are added to the on and off times at step 736. The substantially random time is preferably a random value between plus and minus fifteen minutes, although other limits are contemplated to be within the scope of the invention. The power relay is switched on and a new random on time is calculated at step 740 if step 738 determines the clock time to be equal to the event on time. The power relay is switched off and a new random off time is calculated at step 744 if step 742 determines the clock time to be equal to the event on time. Then step 746 displays the time and the process flow returns to FIG. 6 through connector A at step 750.

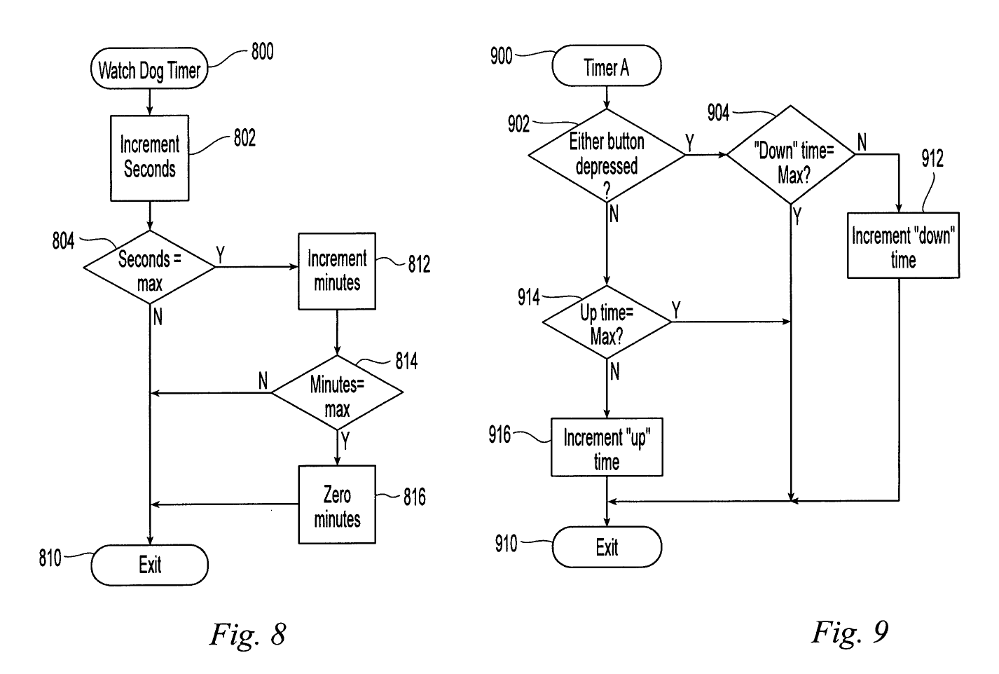

FIG. 8 shows a process flow routine of a watch dog timer operating in accordance with the operation of the present invention. The routine is entered at step 800 and step 802 increments the seconds. The routine exits at step 810 if at step 804 the seconds are not equal to a predetermined maximum. If equal, then step 812 increments the minutes and step 814 determines if the minutes equal a predetermined maximum. If true then the minutes are set to zero and the process exits at step 810.

FIG. 9 shows a process flow routine of timer A operating in accordance with the operation of the present invention. The routine is entered at step 900. If either timer button is pressed at step 904 and the down time equals a predetermined maximum at step 904 then the routine exits at step 910. If the down time is not max then the down time is incremented at step 912 and the routine exits at step 910. Otherwise step 914 determines if the up time equals a predetermined maximum and if not the up time is incremented at step 916. The process then exits at step 910.

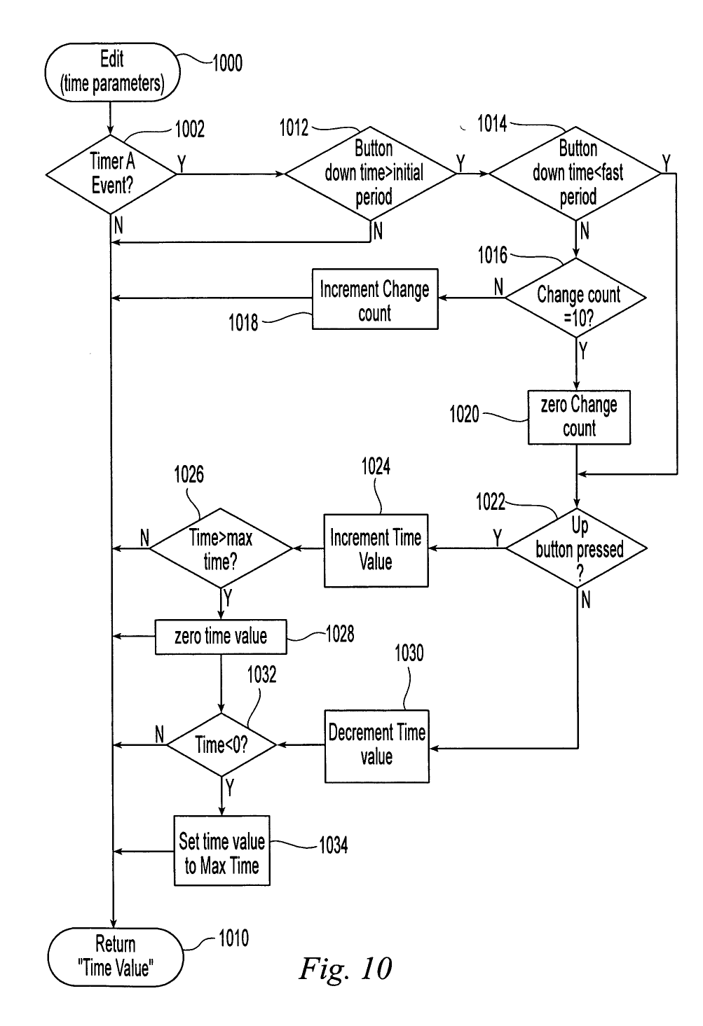

FIG. 10 shows a process flow routine for the processing of a timer A event in accordance with the operation of the present invention. Through step 1000, step 1002 determines if a Timer A event has occurred and if not the process exits at step 1010. Otherwise, step 1012 determines if the down button time is greater than an initial period, then the process exits at step 1010. Otherwise, step 1014 determines if the button down time is not greater than a fast period and then step 1016 causes step 1018 to increment the change count if the change count does not equal 10. If at step 1016 the change count equals 10 then the change count is set to zero at step 1020. Proceeding to step 1022, if the up button is pressed, then step 1024 increments the time value and if the time is less than a maximum time, step 1026 cause the process flow to exit at step 1010. Otherwise the time value is set to zero at step 1028 prior to exiting at step 1010. If the up button is not pressed at step 1022 then step 1030 decrements the time value and if time is less than zero at step 1032 the process returns at step 1010. Otherwise the set time value is set to a maximum time at step 1034 and the process exits at step 1010.

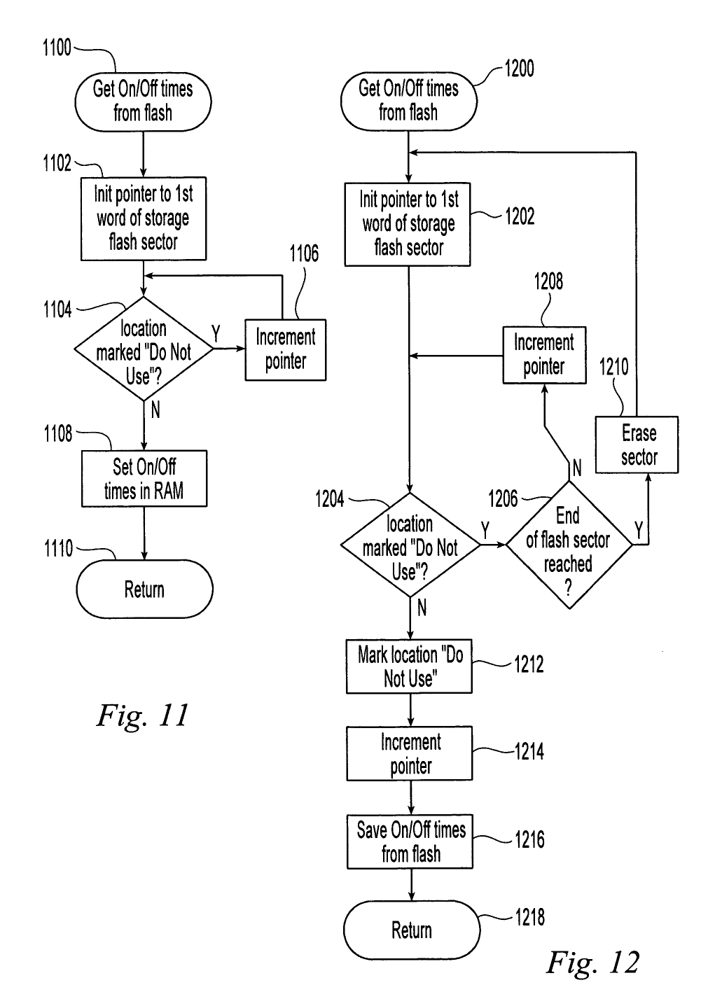

FIG. 11 shows a process flow routine for retrieving on and off times from nonvolatile flash memory. The routine enters at step 1100 and at step 1102 the pointer is initialized to first word of storage in the flash sector. If the location is marked as a “do not use” at step 1104 then the pointer is incremented at step 1106 and looped back to step 1104. Ultimately step 1108 sets the on and off times in RAM and the process flow returns through step 1110.

FIG. 12 shows a process flow routine for saving on and off times in nonvolatile flash memory. The routine enters at step 1200 and the pointer is initialized to the first word of storage in the flash memory. If the location is flagged as a do not use at step 1206 and if the end of the flash is not reached at step 1206 then the pointer is incremented at step 1208, otherwise the sector is erased at step 1210. If the location may be used at step 1204, then step 1212 marks the location as a do not use, the pointer is incremented at step 1214 and the on and off times are stored in flash memory at step 1216 prior to the process returning at step 1218.

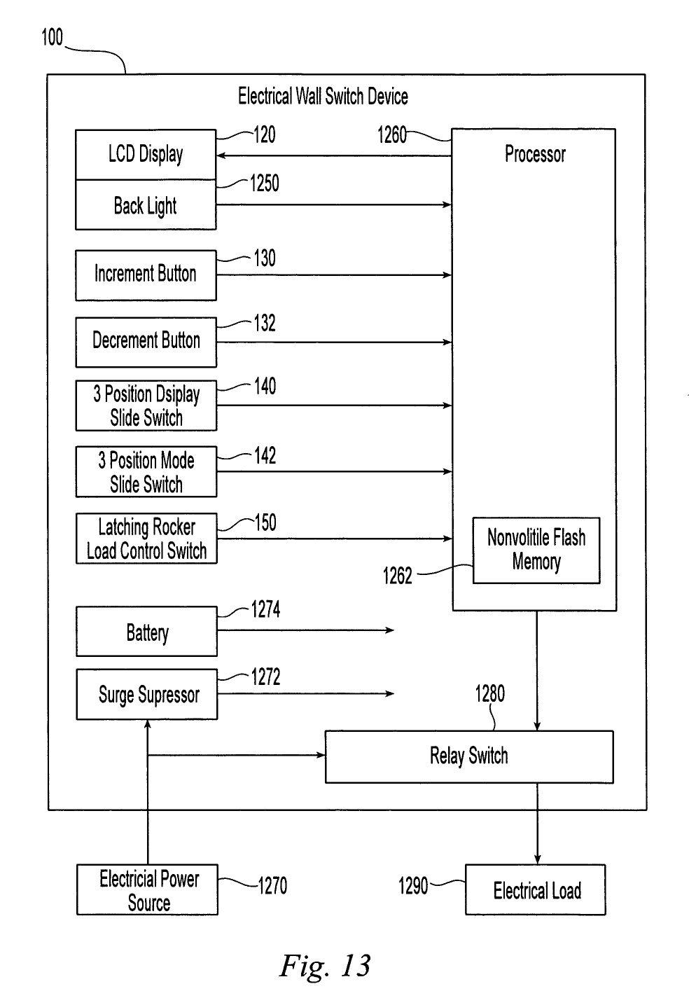

FIG. 13 shows a block diagram of the electrical wall switch operating in accordance with the present invention. As substantially shown in FIG. 1, the electrical wall device 100 has an LCD display 120 with an optional backlight 1250 as well as increment and decrement buttons 130 and 132. There is a three position display slide switch 140, a three position mode slide switch 142 and a latching rocker load control switch 150. The system is controlled by a control circuit including a microprocessor 1260 which is preferably a MSP430 family microcomputer manufactured by Texas Instruments which may include nonvolatile flash memory 1262. Electrical power source 1270 is a conventional alternating current power source available to many residential and commercial applications and powers the control circuitry through surge suppressor 1272 which protects the control circuits from transients received from the electrical power source or generated by the electrical load 1290 or the switching of the electrical load by relay switch 1280. Relay switch is controlled by processor 1290 as previously described and may be a mechanical or solid state switch. Battery 1274 optionally may be used to preserve the memory in the event of failure of the electrical power source 1270 and may be permanently installed or replaceable and may be rechargeable or non-rechargeable.

Thus, the improved wall switch that provides the look and feel of a conventional DECORA-type electrical wall switch. The switch provides for normal operation of a conventional wall switch, in addition to automatic timer controls. Those familiar with the art will appreciate that the afore described switch may be readily modified for three-way and other multi-way switching. The standard dimensions and electrical connections provide for easy installation in either new building construction or existing wall switch replacement with the use of standard hand tools. Furthermore, the programming interface, menus, icons and buttons are easy to use and simple to understand. This is due in part because there are substantially no multi-functional processes associated with the switches and programming, thereby simplifying understanding of the programming and operation of the device. That is, each of the three positions switch positions have a single function, the user need not look at display icons to determine the current switch function. There is an easy to read LCD clock readout that may be read with or without the optional backlight. Memory may be retained without the need of an additional external DC power source such as a battery. Protection against transient voltage is provided. The slim mount design incorporates adequate and generally accepted human factors engineering concepts. The unit is substantially maintenance free, affordable and easy to install and operate.

The preferred embodiment requires an input of 120 VAC, 60 Hz and switches either 15A resistive, 15A inductive, 500W incandescent or ⅓ HP motor loads. The switch mounts to industry standard single-wide (1-gang) or multiple-gang electrical junction boxes. The mount is flush to the junction box and readily accepts DECORA style wall plates. The switch provides normal ON/OFF operation of a conventional 2-way electrical switch. Those familiar with the art appreciate that the operation may also include conventional 3 (or more)-way electrical switch (which may be accomplished with external wiring jumpers or alternate methods). The switch provides a manual override option which will enable the user to operate the switch manually, thus bypassing any and all timer functions. The timer could be in RUN mode and when the user operates the toggle switch, the circuit would be controlled accordingly by the user and toggle appropriate circuit electrical load ON or OFF. The switch provides for one timer on and off command set and a means to program or set the time of day to activate the timer in a single 24-hour period. The switch provides for an embedded real-time system clock and the means to program or set the correct time of day. The switch has a random automatic timer controlled setting to avoid a “controlled timer” look and a means for the user to initiate the random mode. Random setting is preferreably plus or minus fifteen minutes from the user programmed on and off times. A system reset is also provided to reset all internal memory to a base setting.

In the preferred embodiment, the switch has an internal memory backup power that would last at least ten years under normal storage conditions. The device can go to “sleep” while in this mode, thus turning OFF the display and any or all user interfaces. When AC power is restored the control circuits will wake-up and initialize in an appropriate amount of time, resuming normal operation and memory settings. The switch further has internal solid-state surge suppression circuitry to provide system protection from at least 2000 V transient voltage and 70A transient spikes.

Thus, what is provided is a programmable timer that is easy to use and user friendly with the look and feel of a conventional wall switch. The programmable timer fits in a conventional single or multiple gang electrical box for housing conventional manual wall switches and has a rectangular control surface occupying the control area providing a conventional DECORA-type wall plate. It will be appreciated by those skilled in the art that numerous modifications and variations may be made to the description provided herein while remaining within the scope of the present invention. These modifications and other equivalent structures may be substituted without departing from the spirit and scope of the present invention. The scope of the invention is not to be restricted, therefore, to the specific embodiments described, and that equivalent applications, modification, and embodiments within the scope of the invention are contemplated.

1. An electrical wall switch device for automatically and manually turning on and off an electrical load, the electrical wall switch device having a control surface occupying a compact predefined area comprising:
a manual load control switch occupying a first portion of the predefined area for receiving manual inputs for turning on and off the electrical load; and
a time display for selectively displaying time of day, a load on time and a load off time, said time display occupying a second portion of the predefined area, wherein the first portion of the predefined area appears larger than the second portion of the predefined area.

2. The electrical wall switch device according to claim 1 wherein said manual load control switch is a latching rocker-type load switch.

3. The electrical wall switch device according to claim 1 wherein said manual load control switch is a latching toggle-type load switch.

4. The electrical wall switch device according to claim 1 wherein said manual load control switch is a latching snap action-type load switch.

5. The electrical wall switch device according to claim 1 wherein said manual load control switch is a momentary rocker-type load switch.

6. The electrical wall switch device according to claim 1 wherein said manual load control switch is a momentary toggle-type load switch.

7. The electrical wall switch device according to claim 1 wherein said manual load control switch is a momentary snap action-type load switch.

8. The electrical wall switch device according to claim 1 wherein said manual load control switch is a momentary membrane-type load switch.

9. The electrical wall switch device according to claim 1 wherein said manual load control switch is a vertically mounted rocker-type load switch.

10. The electrical wall switch device according to claim 1 wherein said manual load control switch is a horizontally toggle-type load switch.

11. The electrical wall switch device according to claim 1 wherein the predefined area measures substantially one and one half inches by two and six tenths inches.

12. The electrical wall switch device according to claim 1 wherein the compact predefined area further comprises
a multiplicity of control switches comprised within a third portion of the predefined area wherein the predefined area is substantially comprised of the first, second and third portions and further wherein the first portion of the predefined area appears larger than the third portion of the predefined area,
thereby providing the appearance of the manual load control switch as occupying the largest portion of the predefined area and simplifying a perceptual manual control of the load using the electrical wall switch device.

13. The electrical wall switch according to claim 12 wherein said multiplicity of control switches includes:
a display control switch having three positions, a first of three positions for causing display of the load turn on time on said time display, a second of three positions for causing display of the time of day on said time display, and a third of three positions for causing display of the load turn off time on said time display; and
a mode switch comprising at least two positions, a first of the at least two positions enabling turning on and off the electrical load by said manual load control switch, and a second of the at least two positions enabling automatic load control.

14. A simple to program electrical wall switch device for automatically and manually turning on and off an electrical load comprising:
a time display for displaying time of day, a load turn on time and a load turn off time;
a manual load control switch for receiving manual inputs for turning on and off the electrical load;
a display control switch containing three positions, a first of three positions for causing display of the load turn on time on said time display, a second of three positions for causing display of the time of day on said time display, and a third of three positions for causing display of the load turn off time on said time display; and
a mode switch comprising at least two positions, a first of the at least two positions enabling turning on and off the electrical load by said manual load control switch, and a second of the at least two positions enabling automatic load control.

15. The simple to program electrical wall switch device according to claim 14 wherein said mode switch has substantially only three positions and the third position at least partially randomizes a timing of the automatic load control.

16. The simple to program electrical wall switch device according to claim 14 comprising a backlight for illuminating said time display.

17. The simple to program electrical wall switch device according to claim 14 comprising a memory for storing substantially only one load turn on time and substantially only one load turn off time.

18. The simple to program electrical wall device according to claim 17 further comprising a permanently installed non-rechargeable battery coupled to said memory for providing backup power to said memory.

19. The simple to program electrical wall device according to claim 17 further comprising a permanently installed rechargeable battery coupled to said memory for providing backup power to said memory.

20. The simple to program electrical wall switch device according to claim 14 wherein the first position of said mode switch further enables
selecting a turn on time set mode if said display control switch is in the first position,
selecting a time of day set mode if said display control switch is in the second position, and
selecting a turn off time set mode if said display control switch is in the third position,
thereby providing a simplified mode selection for setting the load turn on time, the time of day and the load turn off time.

21. The simple to program electrical wall switch device according to claim 14 further comprising
an increment switch; and
a decrement switch, wherein the first position of said mode switch further enables
selecting a turn on time set mode if said display control switch is in the first position and
incrementing the load turn on time in response to manual activation of said increment switch and
decrementing the load turn on time in response to manual activation of said decrement switch,
selecting a time of day set mode if said display control switch is in the second position, and
incrementing the time of day in response to manual activation of said increment switch and
decrementing the time of day in response to manual activation of said decrement switch, and
selecting a turn off time set mode if said display control switch is in the third position and
incrementing the load turn off time in response to manual activation of said increment switch and
decrementing the load turn off time in response to manual activation of said decrement switch,
thereby providing a simplified setting the load turn on time, the time of day and the load turn off time.

22. The simple to program electrical wall switch device according to claim 21 further comprising:
an electrically powered control circuit drawing power from the electrical power source for controlling the automatic turn on and turn off of the electrical load; and
a surge voltage suppression circuit coupled between the electrical power source and said control circuit for protecting said control circuit from damages due to voltage surges from the coupling to the external power source and the electrical load.

23. An electrical wall switch device having a multiplicity of control switches for automatically and manually turning on and off an electrical load, the electrical wall switch device having a control surface occupying a compact predefined area comprising:
a manual load control switch of the multiplicity of control switches occupying a first portion of the predefined area for receiving manual inputs for turning on and off the electrical load; and
a remainder of the multiplicity control switches comprised within a second portion of the predefined area wherein the first portion of the predefined area appears larger than the second portion of the predefined area.

24. The compact predefined area of electrical wall switch device according to claim 23, further comprising
a time display for displaying time of day, a load on time and a load off time, said time display occupying a third portion of the predefined area wherein the predefined area is substantially comprised of the first, second and third portions and further wherein the first portion of the predefined area appears larger than the third portion of the predefined area,
thereby providing the appearance of said manual load control switch as occupying the largest portion of the predefined area and simplifying a perceptual manual control of the load using the electrical wall switch device.

25. The electrical wall switch according to claim 24 wherein said remainder of the multiplicity of control switches comprise:
a display control switch containing three positions, a first of three positions for causing display of the load turn on time on said time display, a second of three positions for causing display of the time of day on said time display, and a third of three positions for causing display of the load turn off time on said time display; and
a mode switch comprising at least two positions, a first of the at least two positions enabling turning on and off the electrical load by said manual load control switch, and a second of the at least two positions enabling automatic load control.

26. The simple to program electrical wall switch device according to claim 25 wherein the first position of said mode switch further enables
selecting a turn on time set mode if said display control switch is in the first position,
selecting a time of day set mode if said display control switch is in the second position, and
selecting a turn off time set mode if said display control switch is in the third position,
thereby providing a simplified mode selection for setting the load turn on time, the time of day and the load turn off time.

27. The simple to program electrical wall switch device according to claim 25 further comprising
an increment switch; and
a decrement switch, wherein the first position of said mode switch further enables
selecting a turn on time set mode if said display control switch is in the first position and
incrementing the load turn on time in response to manual activation of said increment switch and
decrementing the load turn on time in response to manual activation of said decrement switch,
selecting a time of day set mode if said display control switch is in the second position, and
incrementing the time of day in response to manual activation of said increment switch and
decrementing the time of day in response to manual activation of said decrement switch, and
selecting a turn off time set mode if said display control switch is in the third position and
incrementing the load turn off time in response to manual activation of said increment switch and
decrementing the load turn off time in response to manual activation of said decrement switch,
thereby providing a simplified setting the load turn on time, the time of day and the load turn off time.
